(19) United States
(12) Patent Application Publication
(10) Pub. No.: US 2011/0099142 A1
(43) Pub. Date: Apr. 28, 2011

(54) MOBILE TERMINAL AND METHOD FOR PROVIDING LIFE OBSERVATIONS AND A RELATED SERVER ARRANGEMENT AND METHOD WITH DATA ANALYSIS, DISTRIBUTION AND TERMINAL GUIDING

(75) Inventors: Juha Karjalainen, Helsinki (FI); Hannu Verkasalo, Espoo (FI)

(73) Assignee: ZOKEM OY, Espoo (FI)

(21) Appl. No.: 13/001,492

(22) PCT Filed: Mar. 9, 2009
(86) PCT No.: PCT/FI2009/050186

§ 371 Date: Dec. 27, 2010

(51) Int. Cl. G06F 7/00; H04W 88/02

(52) U.S. Cl. 707/600; 455/550.1; 707/E17.033

(57) ABSTRACT

A mobile terminal for providing life observations including: a processing entity, memory, a wireless transceiver for wirelessly transmitting and receiving data relative to external entities, an observation logic conducting active and passive observations detectable relative the mobile terminal in response to active and passive triggers, respectively, each active trigger being associated with a triggering rule for conducting a related observation, each passive trigger being associated with a change in the observation environment, the occurrence of which in the mobile terminal triggers conducting the observation linked to the passive trigger, and a data handling logic for storing, analyzing, and aggregating observation data points of the gathered observation data to timed observation data transmissions via the wireless transceiver towards an external entity. A server arrangement for analyzing context and behavior modelling using observations from plural mobile terminals and guiding the mobile terminals for future observations is also presented, with corresponding methods.

### FIELD OF THE INVENTION

The present invention generally relates to mobile devices and communications networks. In particular the invention pertains to performing observations in one or more mobile terminals and processing and distributing the related data on the server side through customized interfaces utilizing cumulative and centralized intelligence for data handling.

### BACKGROUND OF THE INVENTION

A number of solutions, such as GPS (Global Positioning System), are already available for locating people provided with a mobile device incorporating an associated positioning device, such as a GPS receiver. People can also send photos or micro-blog entries to the web through utilization of various tools built for smartphones that are in this particular context deemed as mobile phones capable of running add-on applications with packet data connectivity enabled. Accordingly, social media applications such as Facebook, MySpace and LinkedIn have gained huge popularity among the Internet users since the beginning of the 2000's. The users belonging to the same sub-community, for example a certain circle of ‘friends’ or ‘contacts’, may often contribute to others' profiles and share thoughts, files, links, and applications via the common service whereas the remaining users being not members of the same sub-community may only access limited, if any, information related thereto. The social networking solutions thus try to combine features from more traditional, either paper-form or electronic, personal address books, calendars, blogs, and web pages into an aggregate (social) life portal for also others to use.

Current social networking sites and derivatives thereof, such as different lifestreaming or ‘life-blogging’ solutions, concentrate on the Internet as an access medium and service carrier both alike. Thereby, using such sites requires accessing a web service for practically any related task including signing in and maintaining a profile, adding new friends/contacts to the related account, and uploading/updating profile related supplementary information such as photos, messages, status/context information and applications. The arranged access is typically manual in a sense that the user logs in the system and configures the account step-by-step until the next visit, although certain lifestreaming applications such as Tumblr or Lifestre.as can be configured to maintain a user's life profile up-to-date by automated information retrieval from a number of other specifically selected web pages e.g. by RSS (Really Simple Syndication). Typically the information content of such sources is maintained manually, i.e. a blog owner simply types in the articles via the keyboard or clicks a certain applet-specific symbol in a browser to send a link of the current web page into his blog, etc.

It seems that in the light of rather dominant near-future trend various smartphones will emerge as the sole digital devices that people really bother to carry with them on a daily basis. Smartphones will function as communication devices, authentication tools, digital wallets and keys, etc. all alike. In this scenario, smartphones could also be exploited as always-on observers of life. Smartphone devices are possibly in the best position to become universal digital observers, being able to track locations, temperatures, movements, communication activities, proximity to other people, social interactions, etc. There is no strict limit with regard to the possible observations as various kinds of observers and sensors may be included in the smartphones. For example, in the future the smartphones might collect a rich feed of data containing comprehensive audio and video recordings relative to each day, and thus let the people generate a digital storage of their life lived.

Data that can be collected in a smartphone can naturally be used locally in the same device. For instance, temperature data can be shown on the screen of the phone. However, some data may be at least occasionally worth sending to other people, for example the current location of the device might form a useful piece of information for other people considering e.g. different “buddy tracking” purposes. One drawback associated with the contemporary solutions is that they typically implement straightforward end-to-end pipelines more or less focusing on certain kinds of data items only. In addition, the users may have to manually enable or conduct the data acquisition phase and even perform dedicated follow-up actions such as sending the data by specifically selecting an update feature of the relevant application. Moreover, in many cases the disclosed solutions are extremely simple, if not frankly dumb, i.e. a sensor reading is obtained in the device and then just some straightforward continuation operation such as visualization or storage is done relative to this data.

A number of prior art arrangements propose to collect data points, position the user, or to make contextual data points locally available to other applications of the particular phone. For example, prior art publication WO2008118119 discloses a mobile device and a method for communicating positioning data of the mobile device to a server at a periodic interval, then automatically generating in the mobile device, in response to the server, a present location profile associated with a present geographic location of the mobile device, simultaneously generating, in the mobile device, a set of adjacent profiles provided by the server as being a direction away from the present geographic location of the mobile device, and refreshing in the mobile device, the present location profile and the set of adjacent profiles at the periodic interval.

Notwithstanding the various prior art solutions for storing mobile-related events, there still exists room for improvement in the light of many aforementioned issues. The existing arrangements highly rely on manual labour, are more or less use-case centric, typically monitor only a very limited number of rather simple events according to a fixed and substantially memoryless scheme, and store and distribute the gathered data basically as is. Additionally, the existing social lifestreaming applications heavily focus on the life feeds of the web, containing, for example, information on people's activities in web-based social networking services or other directly web-related actions such as photo uploads.

### SUMMARY OF THE INVENTION

The objective of the present invention is to alleviate at least some of the drawbacks of the prior art solutions and provide a more intelligent, flexible and adaptive alternative for observing the life of mobile users.

The objective is achieved via a mobile terminal and a service arrangement of the present invention. The present invention proposes a bi-centralized approach, in which one or more mobile terminals may automatically collect a considerable amount of behavioural, technical and contextual data, i.e. observation data and further automatically transmit at least part of the gathered data to one or more servers at the optimal time instant, optionally also receiving contextual intelligence from the server(s) to be used in the mobile devices for data acquisition. The server side is preferably made primarily responsible for managing the cumulative intelligence, linkage between one specific device and other devices, external environment, and/or historical data, the present invention thus suggesting a novel methodology, in contrast to, for example, one-way pipelines, for sharing data by the wireless mobile devices to the external world. The present invention may be implemented as software architecture for automatically conducting triggered observations in a mobile terminal and optimally converting these observations into life feed data, which can be further processed and enriched with a centralized server-side software component and provided to external systems via a standardized data distribution interface. The suggested novel approach for collecting, transmitting and distributing life feed data in accordance with the embodiments of the present invention advantageously results in a more modular, smarter and flexible overall solution that makes a distinction between the layers of data collection with pre-processing (i.e. the mobile agent part arranged in the mobile terminal), and data processing with centralized intelligence and distribution facilities (i.e. the server arrangement).

Thereby, in one aspect of the present invention, a mobile terminal for providing life observations, such as a smartphone, comprises a processing entity for processing data, a memory for storing data, a wireless transceiver for wirelessly transmitting and receiving data relative to external entities, such as a communications network infrastructure, the device further comprising
an observation logic, executed by said processing entity and stored in said memory, for conducting active and passive observations on events, actions and/or properties detectable relative to the mobile terminal in response to active and passive triggers, respectively, wherein each active trigger is associated with a triggering rule for conducting a related observation, and each passive trigger is associated with a change in the observation environment, such as an event or action, the occurrence of which in the mobile terminal triggers conducting the observation linked to said passive trigger, and
a data handling logic, executed by said processing entity and stored in said memory, for storing, analysing, and aggregating observation data points of the gathered observation data to timed observation data transmissions via the wireless transceiver towards an external entity.

The mobile terminal according to any embodiment of the present invention thereby comprises at least one wireless communications transceiver. Non-limiting examples of the transceivers include a GSM (Global System for Mobile Communications) transceiver, a GPRS (General Packet Radio Service) transceiver, an EDGE (Enhanced Data rates for Global Evolution) transceiver, a UMTS (Universal Mobile Telecommunications System) transceiver, a WCDMA (wideband code division multiple access) transceiver, a PDC (Personal Digital Cellular) transceiver, a PHS (Personal Handy-phone System) transceiver, and a WLAN (Wireless LAN, wireless local area network) transceiver. The transceiver may be such that it is configured to co-operate with a predetermined communications network (infrastructure), such as the transceivers listed above. The network may further connect to other networks and provide versatile switching means for establishing circuit switched and/or packet switched connections between the two end points. In addition/alternatively the device may comprise a wireless transceiver such as a Bluetooth adapter meant for peer-to-peer communication and e.g. piconet/scatternet use. In addition, the terminal may comprise interface(s) for wired connections and associated communication relative to external entities, such as an USB (Universal Serial Bus) interface or a Firewire interface.

The events may include, for example, substantially non-user-initiated incidents, such as battery status change, not at least directly initiated by the user of the device. The actions may include substantially user-initiated intentional activities and incidents, for example use of the web browser, movements, reading a message, etc. Some incidents may be also considered to conveniently fit both the above incident classes.

Embodiments of the mobile terminal further apply different triggers and preferably also smart algorithms that coordinate performing observations and/or data transmissions. For example, when the user places a voice call to somebody, this can be used to trigger an automatic observation of the location through e.g. GPS (which automatically also/alternatively triggers a poll on base station tower information), after which an automatic data transmission may take place. Consequently the server side may be provided with near to real-time knowledge about each user's recent communication activities. The triggers can be based on hard-coded known dynamics, such as base station changes (that typically reflect movements if they happen frequently), or alternatively on self-learning, adaptive logic, or both. For example, the mobile terminal, particularly a so-called intelligence engine therein, may be configured to recognize patterns that occur at regular basis. For instance, it may be noticed that the user typically updates tomorrow's calendar entries always at about 23 pm in the evening, leading to a smart rule of checking the calendar content always at 23:30 pm every day.

The observation logic is preferably tied natively to the mobile device without using middle layer platforms, this approach facilitating direct observations, smarter logic, better access to platform stable process, and little intervention in other processes. The observation logic is also preferably enabled to pre-process the observation data on the raw-level format, which may refer to the verification of a data point's validity, dropping duplicate observations, calculating indices (averages), normalizing observations, and/or other ways making the data flow smoother, optimized (volume-wise) or more reliable. Data conversion and pre-processing part of the observation logic may also be configured to utilize feedback from remote entities, and overall intelligence, which might be linked to contextual factors, too. Thus in one embodiment the observation logic is configured to utilize the input by external entities such as the server. The input may comprise intelligence provided by the external entities in terms of e.g. weather conditions, cellular network topology, and/or activities of the social network in the form of rules, for example, whereupon the mobile terminal may be configured to apply such input to improve and update the operations of the observation logic. For instance, a data input module and/or data handling agent may be utilized in providing the instructions, being locally generated and/or received from external entities, to the observation logic.

Nevertheless, the observation logic is enabled to conduct active observations, meaning, for example, scanning the device memory or available Bluetooth connections. Active observations are substantially done on the basis of active triggers (i.e. not based on sensing anything on the level of observations) and consequent observations done via device APIs. Further, the observation logic supports passive observations, which are based on sensing the observation environment meaning that being induced by e.g. change(s) in the observation environment, which can be traced through operating system's APIs, a data point can be written down. Low-level device interfaces can be registered accordingly so that when a change happens, an observation is really made. As a tangible, though purely exemplary, use case, upon recognizing that the active base station has changed an associated observation can be made so that the details of the base station with all the necessary parameters like signal strength and timing advance will be scanned. Accordingly, a related data point may be written into the log. The observation logic may collect data points based on communication actions (for instance, initiating a call, answering a call, sending a message such as an SMS (Short Message Service), MMS (Multimedia Message Service), or e-mail message, receiving a corresponding message, etc.), sensor data (e.g. temperature, acceleration, position (orientation and/or location via e.g. GPS/cell identification/triangulation), light intensity), application usage, microphone usage, loudspeaker/audio output such as music reproduction, camera usage, any user input or action in general, calendar entries (additions/deletions and/or actual realization/activation thereof), and in principle the observations can range from simple temperature-type logging to all-day audio and video recordings, for instance, which are automatically observed (˜recorded) in the device.

The mobile terminal preferably supports multi-thread observation logic, i.e. each observation is done in a separate process, without intervening with other processes of applications. In extreme cases, such as problems in reading data and consequent crash of that thread, the other applications do not face problems. Conducting observations is guided by the aforementioned intelligent triggering logic, preferably customizing observations based on the nature and/or importance (priority ranking) of the data point, contextual factors, external input, and/or existing technical restrictions.

As alluded above, the various embodiments of the mobile terminal preferably include logics for intelligent pre-processing and/or filtering of the life feed data locally. Particularly when the amount of life feed data observed from device APIs is considerable, a possibility to filter out irrelevant data is essential. The filtering logic, data handling logic in general and thus the overall intelligence of the terminal may be advantageously functionally linked to the server-side environment in order to obtain instructions therefrom facilitating, for example, the update of locally applied rules and algorithms, and offering benefits arising from the availability of wider datasets in the server environment (for instance, in recognizing patterns). Depending on the embodiment the mobile terminal is thus self-learning, adaptive, and/or incorporates input from the server-side intelligence repository. The mobile terminal may specifically include the aforementioned data input module for obtaining the external input.

Preferably the mobile terminal is configured to push the data towards servers at appropriate time instants. For example, the intelligence engine of the terminal, which may be in practice functionally spread between several functional entities of the terminal such as the observation logic (observation intelligence engine) and data handling agent (mobile intelligence engine), may determine the optimal time to transmit the processed data from devices to server(s). The intelligence may be implemented using contextual triggers (e.g. location changes), behavioural triggers (e.g. user's actions), time limits (e.g. regular transmission), emergency transmits (for instance, when fire observed in the proximity of the phone), cost-efficiency (transmitting after a certain threshold of data is collected to local memory, limiting the costs of transmission) and battery-optimization (saving as much of the battery as possible). The intelligence engine is preferably capable of learning from the collected data, observed patterns, and/or input from external entities such as servers, and adapt to contextual dimensions as well.

In one embodiment, a data handling agent mainly coordinates the rich data flow output by the observation logic, thus for its part maintaining the overall agent-side intelligence of the system logic, and transmits the observed data to servers. The data handling agent is preferably capable of streamlining and filtering data by the data observation logic, combining data points (adding, for example, active cellular base stations indices to battery level changes), enriching data (for example, adding temperature to obtained GPS coordinates) and/or in other ways converting the stream of data into a more meaningful and richer information flow. In addition, the data handling agent may maintain an intelligence repository such as at least part of the aforesaid mobile intelligence engine, meaning the overall rules how to conduct, organize, process and transmit data, whereas the observation intelligence engine may control what, how and when to conduct observations on the mobile agent side. The mobile intelligence engine may receive input from the external entity such as a server module, e.g. through one or more data input APIs. For example, the status of the user's friends can be provided by a server, which is optionally configured to activate a more frequent location retrieving in the terminal (and observation logic thereof) provided that the user and his friend are approaching the same location and thereby with high likelihood could meet at some point. The data handling agent is preferably enabled to store the observation data stream and intelligence data in a local memory for temporary storage. The data handling agent also performs data transmission, this optionally involving authentication, encryption and/or other type of securing the data streams and connections. Data transmission, as the whole logic of the data handling agent, may be based on triggers and adaptive rules that make it flexible and adjustable to different situations and use cases. The data handling agent may interact with the user interface of the device, for example in mapping subjective information or semantic data asked directly from the users to observations.

In the embodiments of the mobile terminal, one or more data input modules may be used for receiving data from external entities such as the server side. In one embodiment, a data input is automatically started when the connection is open towards the server (i.e. when triggered data transmission towards the server takes place). It may, however, operate independently. The data input module may have a processing logic of its own to categorize and makes sense out of the received data, and optimally inform the data handling agent about it. For example, simple contextual parameters like temperature might be directly stored in a temporal cache memory to be used by e.g. the data handling agent for enriching observations, but on the other hand intelligence rules (such as the fact that in the current operator's network the frequency of network tower polling should be 50% more frequent in daytime) will be incorporated in the set of rules making up the intelligence logic of the whole mobile agent. Such intelligence logic may be maintained by the data handling agent and optionally the observation logic, for instance, as to be reviewed hereinafter. The data input module is also responsible for managing and transmitting (to the data handling agent) a variety of intelligent messages that need to be pushed to the user interface of the wireless device, ranging from geo-social advertisements to contextual notifications from other wireless devices.

In another aspect, a method for providing life observations based on events, actions and/or properties detectable in a mobile device, comprises

determining a number of active and passive triggers for conducting active and passive observations on events, actions and/or properties detectable relative to the device, respectively, each active trigger associated with a triggering rule, such as a timing rule, for conducting a related observation, and each passive trigger associated with a change in the observation environment, such as a certain event or action, the occurrence of which in the device triggers conducting the observation linked to said passive trigger,
conducting active and passive observations in the device in response to the fulfillment of corresponding triggering conditions determined by the active and passive triggers, respectively, and
storing, analysing, and aggregating observation data points of the gathered observation data to timed observation data transmissions towards an external entity.

In a further aspect of the present invention, a server arrangement for analysis, distribution and control of mobile terminal-based life observations relative to a number of mobile users comprises at least one processing entity for processing data, a memory for storing data, and a communications interface for transferring data,

an analytics and data processing logic, executed by said processing entity and stored in said memory, for obtaining triggered observation data transmissions on events, actions and/or properties relative to each mobile terminal from a plurality of mobile terminals and optionally supplementary data from a number of other external data sources, and performing analysis, said analysis comprising context and behavioural modeling, collectively applying the observation data by a plurality of mobile terminals and optional supplementary data, and
a data distribution logic, executed by said processing entity and stored in said memory, for guiding conducting observations in the mobile terminals by control data, such as instructions, established on the basis of the analysis and sent towards mobile terminals via the communications interface, and optionally for providing other external entities with analysis results.

Still in a further aspect, a method for analysing and controlling mobile device-based life observations relative to a number of mobile users, comprises

obtaining triggered observation data transmissions on events, actions and/or properties relative to each mobile device from a plurality of mobile devices and optionally supplementary data from a number of other external data sources,
performing analysis, said analysis comprising context and behavioural modelling, collectively applying the observation data by the plurality of mobile devices and optional supplementary data, and
guiding conducting observations in the mobile devices by control data established on the basis of the analysis and sent towards mobile devices via the communications interface, and optionally further providing other external entities with analysis results.

In a preferred embodiment the server arrangement is configured to mutually link observation data points relative to users, locations, contexts, weather and/or any other information. Data aggregation takes place, at least in a limited sense, also in each mobile terminal as described hereinbefore.

In another, either supplementary or alternative, embodiment the server arrangement utilizes gradual aggregation and temporal resolution adjustment for obtained data such that the most current data is very granular and accurate, whereas the more towards the past you go, the more optimized the data storage is. For example, for the past days not all location points are stored, but a weighted average of geo-locations for each hour or day is used instead.

Yet in a further, supplementary or alternative, embodiment the server arrangement maintains, or has at least access to, a social contact (e.g. friends) database indicative of the existing social connections between the users of the mobile terminals.

The server side entity of the present invention is unique in the sense that it incorporates collective wisdom of all devices being connected to the system in contrast to the end-to-end pipelines of prior art. The other advantageous functionalities of the server include bridging external data (for example, weather or traffic information) to device-based data and use of cumulative wisdom from all the possible data points and external APIs in optimizing the internal rules and processes (the intelligence), and also transforming and providing these improved rules to mobile terminals for use in local observation tasks and related local intelligence. In addition, the novel functionalities of the server preferably include pull and/or push mode data distribution APIs that facilitate distribution of multi-dimensional data to external systems and mobile terminals, without specifying these use cases or doing unnecessary assumptions beforehand (the typical shortcoming in prior art solutions).

The server arrangement resides in the intersection of the social networks, external environmental data, specific behavioural and contextual data provided by the mobile devices, and overall intelligence provided by science in general, i.e. algorithms, data aggregation and mining procedures, pattern recognition, semantic structures, etc. It may be configured to enrich the data, update statistical averages, build cumulative databases, make observations across individuals (for example to identify two users' proximity), make predictions by relying on the amount data, and utilizing statistical mathematics in calculating likelihood estimates for different outcomes to happen. The server side intelligence may incorporate, depending on the embodiment, intelligent functionalities such as suggestions of advertisements to specific users, to be sent by these users to other users of their social networks. For example, an individual user popping up in a downtown restaurant can be informed of a happy hour discount for beer in a local bar, and the system suggests to the user the related ad to be sent to one of his friends (thereby leading potentially to a meeting between the friends in the local bar), also located in the neighbourhood. This advertisement, effectively received by the friend through a viral path, is an intentional message from one of his friends or business contacts, not a disturbing pop-up push-mode message by a practically unknown third party as being the case in most prior art solutions for targeted mobile advertising. Thanks to the feedback loop to the mobile agents, these kinds of smart, context-dependent social advertisements can be implemented together with the invention core.

The aforementioned analytics and data processing logic may be implemented as a software module, which acts as a centralized location wherein all external APIs' data (e.g. names of locations, temperatures), device-based data and social network data can be conceptually brought together. An intelligence engine of the server, functionally optionally spread between several entities (into centralized intelligence engine and API intelligence engine, for instance) as to be disclosed herein, coordinates the operations, maintains the set of rules, a sub-set of which will also be sent to mobile agents through the data distribution logic such as a data distribution API, and its internal interface. The centralized and API intelligence engines are preferably adaptive and self-learning, coming up with patterns or other insights regarding, for example, the topology and cellular tower locations of a particular operator's network. A data management module may be applied to maintain the enriched, modified and processed data outputted by enrichment and processing module, which streamlines all the information received, preferably adding semantic dimensions, etc. The data management module may therefore administer vast clusters of databases or database servers, in which all the data (observations, other information, intelligence rules) are stored preferably in a scalable way, the resolution of data stored being gradually narrowed temporally for historical life feed data as mentioned earlier. A data provisioning module may be provided to query the databases in an optimal way, when the need arises, and feed information further to the data distribution API for output.

The utility of the embodiments of the present invention arises from multiple issues. First of all, various embodiments of the present invention facilitate generating a life feed, reflecting real life, relevant data being collected from the true point of presence and end-user inspiration—the mobile terminal. Thus in the context of the present invention a mobile terminal is configured to do what it does best, i.e. to conduct various observations and take care of preferred pre-processing and forwarding thereof. The obtained life feed is preferably multi-dimensional, data points thereof following each other (time-series temporal nature), context-linked and context-aware (e.g. time, status and location), ubiquitous (everywhere, all the time), seamless and automatically created from the user's standpoint. The present invention cleverly integrates various post-processing methods, analysis intelligence, self-learning aspect (e.g. self-learning triggers) and/or adaptive logic.

Automatic observation logic may be arranged in the mobile terminal to run on the background as intelligently triggered and mostly passively with minimum battery consumption and capacity usage, but still with comprehensive data acquisition capability relative to the relevant data points regarding the data associated with a user's life. The observation logic is advantageously completely context-sensitive, predictive and capable of learning from historical data. The collected data points in the mobile phone may be then converted into a life feed, which refers herein to a continuous stream of data points reflecting the timeline of associated people's life.

Further, part of the utility of the present invention lies in the novel way of aggregating, combining, enriching and/or analyzing datasets in a centralized environment, bringing the much needed collective view on the life feed data, and facilitating further coordinated use of the data. Accordingly, the centralized server-side aspect of the present invention is enabled to intelligently process the data (for example, to perform data filtering or clustering), enrich it (for example, to add location names to geo-coordinates), analyze it, e.g. via contextual pattern recognition, build collective real-time intelligence, e.g. via understanding when any two people are actually approaching the same location, and/or to provide the obtained information to external systems with an application programming interface that may be queried on regular intervals and/or dynamically based on separate triggers. In addition, the centralized server-side logic facilitates creating new applications, such as socio-contextual advertising, pushing targeted advertisements to people via their friends' devices, and utilizing intelligent pop-ups in devices as a method of frequent interaction with users. In brief, automated and optimized life observation logic with server-side data processing and integrated application programming interface is provided for data distribution. A specific data distribution API may enable, in view of any use case, versatile exploitation of the observation data by having access to raw-level data items and being configured to streamline raw-level data points to more focused information data points. The distribution layer supports not only static data (such as personal profiles), or dynamic status data (such as current location), but also multi-dimensional time-variant data, which are herein called life feeds.

A further advantageous feature in light of the foregoing is that the system of the present invention does not take a stand on the use of the obtained data. The data distribution API of the server arrangement preferably defines the optimal, comprehensive structures for the whole data intelligence (the highest level of sophistication in the data repository, the information points derived from raw-level data points through several procedures), that can be rapidly accessed when looking for specific data points. The API may be self-learning and adaptive, for example sorting the most highly requested data points to the top, and predicting the data consumption and production unbalances, being able to inform about such important properties of data such as accuracy, validity, and/or consistency. For example, certain location points might have lower resolution and others, and certain status information points might be time-wise non-current. On top of the whole architecture, the data distribution API thus lets a set of external (and internal) modules access the data in a ubiquitous and universal way. Additionally, the users can set their privacy levels and data coordination policies centrally in the server arrangement. Data distribution procedures preferably operate under the rules, restrictions and options set by the user, verifying for each query to which platform the data is flowing, and what the nature, privacy settings and type of the data point is.

As to the terminology generally applied in this document, ubiquitous life feeding is used to refer to automatic collection and processing of life data and enabling the transfer and distribution of this data to external entities. Life feeding may link mobile terminals to e.g. web services in an integrated manner. For example, life feeding applications may enable automatic updating of users' social networking profiles with real-time location and other data provided by the mobile terminals.

A life feed may refer to all information that can be generated in response to monitoring people's everyday life, including for example data on locations, movements, activities and calendar entries. In addition to various actions and events, a life feed can also incorporate user-generated content, such as blog entries and photos. A mobile life feed may be defined as a life feed that can be generated from data provided by a mobile terminal. As deliberated hereinbefore, mobile terminals or their future forms can be considered as best all-around observers of life and thereby also the best automatic generators of life feed.

An API is defined as application programming interface, being e.g. an interface provided by one software module to other modules, typically built for the function of distributing data. An API may support, for example, queries by another system, and then supply data based on the query details. APIs also define the communications and interoperability between modules.

An agent is defined as at least one application in a wireless device, capable of preferably seamless and automatic (not intervening (disrupting) other applications) execution on the background. Agent is enabled to perform operations, and communicate with the Internet, or with other applications.

Observers are defined in this context as processes capable of generating data items, based on e.g. queries and use of the wireless device's operating system capabilities.

Observers are, in a way, sensors, which can automatically sense, for example, changes identified in a cellular base station usage (when the device jumps from the coverage of one tower to the next, for instance). Observers can also refer to channels of user-generated content (for example, blog entries).

Triggers are rules and processes that trigger (induce) a certain action. In particular, the present invention introduces novel algorithms and rules on how the observations can be more effectively and automatically be done in wireless devices. Triggers can be based on time intervals, contextual changes and observations, external requests, or internal requests for example in a situation in which more data is needed for some other datapoints.

The concept of intelligence is used in this document in referring to a set of rules, algorithms, databases and/or processes that coordinate the overall process, or individual micro-processes (for example, the triggering logic). Intelligence is something that makes the system to work smarter, in a more optimal way, saving energy and improving accuracy. The intelligence can be based on fixed and/or self-learning, adaptive algorithms as well as on external input.

A server refers herein to a node in one or more networks, for example Internet. A server can serve clients, in this case for example the mobile agents running in mobile terminals. Clients may thus communicate with one or more centralized servers. Client-server architecture is a commonly used topology of building systems in the Internet.

The concept of processing is used in this document in referring to various kinds of actions than be performed over data. These include data conversions, transformations, formulations, combinations, mash-ups enrichment, correlations, clustering, factoring, normalizing, and filtering, among others, and are applied differently in different situations. Some forms of processing are actively used in various embodiments of the present invention, including combinations and mash-ups (linking data points together and building relational data structures), conversions (generating, for example, meaningful streams of information entities from raw-level, unsorted data items, such as observed location points), enrichment (adding meta data and making the data richer than originally) and filtering (leaving out data that is not relevant or needed anymore).

Viral advertising or geo-social recommendations are in this document used with reference to advertisements or other pieces of corresponding information that people can send to each other, or being directly sent to target people by the server arrangement, tied to a certain context and/or location, and suggested automatically to users to be sent to other users by them, or bundled to other contextual pop-ups in an attractive way.

The expression “a plurality of” refers herein to any integer starting from two (2), e.g. two, three, or four.

The expression “a number of” refers herein to any integer starting from one (1), e.g. one, two, or three.

The expression “data transfer” may refer to transmitting data, receiving data, or both, depending on the role(s) of a particular entity under analysis relative a data transfer action, i.e. a role of a sender, role of a recipient, or both.

In one embodiment and practical use case of the present invention the created system is used to generate an autonomous, seamless, automatic, and continuous stream of life feed data. The system, utilizing both the mobile agent and server side technologies, is enabled to transparently observe different actions and contextual factors relative to a specific user, and thanks to the cumulative social intelligence of the server, automatically alarm people if their friends are in the neighbourhood or if their children already started their way from school back home, for instance.

In another embodiment and practical use case of the present invention, the system may create a digital diary of life, collecting the relevant data points, recording e.g. the day's audio and/or visual environments around the user, with specific contextual tags added (such as location and time), and by enriching such data further with user generated information such as blog entries, to create the most comprehensive diary of life, and let other applications such as Internet services, like social networking services therein, to access this data, by creating a dynamic UI (user interface) to the data.

Various embodiments of the present invention are disclosed in the dependent claims.

### BRIEF DESCRIPTION OF THE DRAWINGS

In the following, the invention is described in more detail by reference to the attached drawings, wherein

FIG. 1 illustrates the general concept of the present invention from a functional standpoint.

FIG. 2 illustrates various features of the present invention via a more technical approach.

FIG. 3 is flow diagram of one embodiment concerning the system incorporating both the mobile terminal and the server arrangement in accordance with the present invention.

FIG. 4 is a flow diagram of one embodiment of the observation logic in the mobile terminal.

FIG. 5 is a flow diagram of one embodiment of the data handling agent in the mobile terminal.

FIG. 6 is a flow diagram of one embodiment of the server-side analytics and data processing logic.

FIG. 7 is a flow diagram of the data distribution API.

FIG. 8 represents a composite flow diagram of two embodiments of a method in accordance with the present invention to be performed by a mobile terminal and a server arrangement, respectively.

### DETAILED DESCRIPTION OF THE EMBODIMENTS

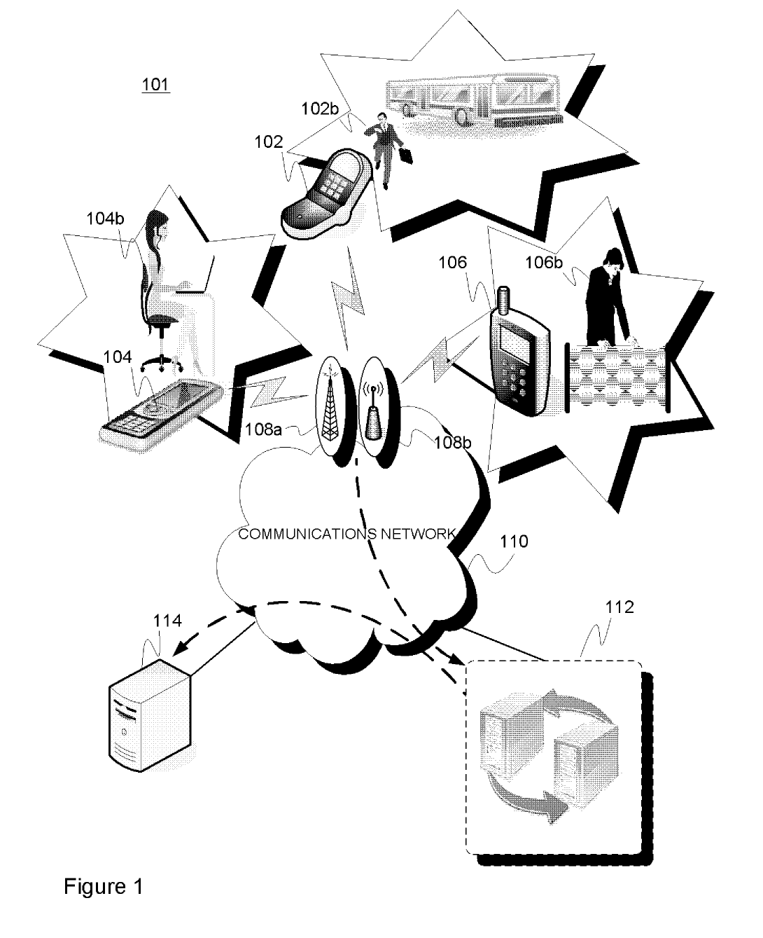

Reverting to the foregoing and with particular reference to FIG. 1, the overall system architecture is illustrated first in a conceptual sense. The whole system is divided into two parts, namely a mobile agent part executed in one or more mobile terminals 102, 104, 106 of users 102b, 104b, 106b, respectively, and a server arrangement part 112 comprising one or more server devices functionally arranged so as to establish a server entity. The users 102b, 104b, and 106b are each living their life in different environments and scenarios, which can be at least partially monitored by the corresponding mobile terminals 102, 104, 106 in accordance with the principles set forth herein. The server 112 is typically connected to a communications network 110 whereto also the mobile terminals 102, 104, 106 are provided with access, e.g. via one or more access networks 108a, 108b, which may be cellular or wireless local area networks, for instance. External entities 114 such as services/servers may be connected to the server arrangement 112 via the network 110, for instance, for obtaining observation data and further data derived therefrom and/or for providing supplementary data such as weather information.

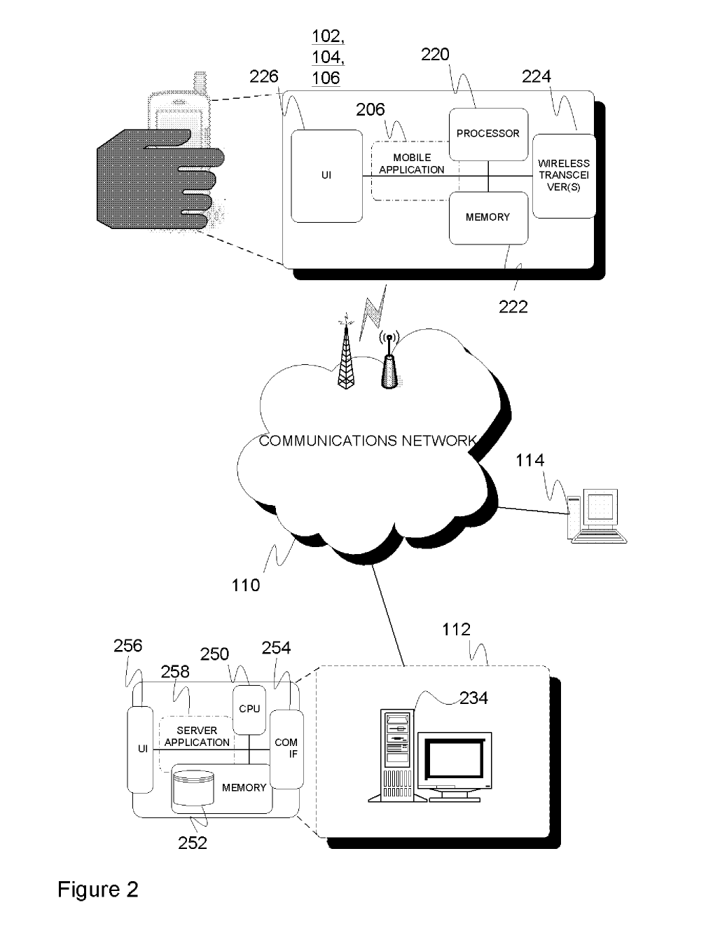

FIG. 2 illustrates various technical aspects of the present invention in light of a certain feasible embodiment. A mobile terminal 102, 104, 106 is typically provided with one or more processing devices capable of processing instructions and other data, such as one or more microprocessors, micro-controllers, DSP's (digital signal processor), programmable logic chips, etc. The processing entity 220 may thus, as a functional entity, physically comprise a plurality of mutually co-operating processors and/or a number of sub-processors connected to a central processing unit, for instance. The processing entity 220 is configured to execute the code stored in a memory 222, which may refer to instructions and data relative to the mobile agent software architecture 206. Software 206 may utilize a dedicated or a shared processor for executing the tasks thereof. Similarly, the memory entity 222 may be divided between one or more physical memory chips or other memory elements. The memory 222 may further refer to and include other storage media such as a preferably detachable memory card, a floppy disc, a CD-ROM, or a fixed storage medium such as a hard drive. The memory 222 may be non-volatile, e.g. ROM, and/or volatile, e.g. RAM, by nature.

The UI (user interface) 226 may comprise a display, and/or a connector to an external display or data projector, and keyboard/keypad or other applicable control input means (e.g. touch screen or voice control input, or separate keys/buttons/knobs/switches) configured to provide the user 102b, 104b, 106b of the device 102, 104, 106 with practicable data visualization and device control means. The UI 226 may include one or more loudspeakers and associated circuitry such as D/A converter(s) for sound output, and a microphone with A/D converter for sound input. In addition, the device 202 comprises a radio part 224 including a wireless transceiver for general communications with other devices and/or a network infrastructure and optional other wireless or wired data connectivity means such as one or more radio transceivers or wired interfaces (e.g. Firewire or USB (Universal Serial Bus)) for communication with other devices such as terminal devices, peripheral devices or network infrastructure(s). It is clear to a skilled person that the device 102, 104, 106 may comprise numerous additional functional and/or structural elements for providing beneficial communication, processing or other features, whereupon this disclosure is not to be construed as limiting the presence of the additional elements in any manner.

As mentioned above, software functionality 206 may be implemented as one or several, mutually communicating, software applications executed by the processor 220. This computer software (product) may be thus provided on a carrier medium such as a memory card, a memory stick, an optical disc (e.g. CD-ROM or DVD), or some other memory carrier. The instructions required for implementing the application(s) may be stored in the carrier medium as executable or in some other, e.g. compressed, format, such that the software may be transported via the carrier medium to a target device and installed therein, e.g. in the hard disk thereof, or executed directly from the carrier medium in the target device by loading the related instructions to the memory 222 of the target device not until execution, for instance. Alternatively, software 206 may be transmitted to a target device over the air via the wireless transceiver or a through a wired communications connection.

Correspondingly, the server arrangement 112 may comprise one or more computer devices 234 comprising a communications interface 254 such as a LAN (Local Area Network) adapter, e.g. Ethernet adapter, a processing entity such as at least one processor 250 for processing data, a memory 252 for storing data, server side software architecture 258 and UI 256.

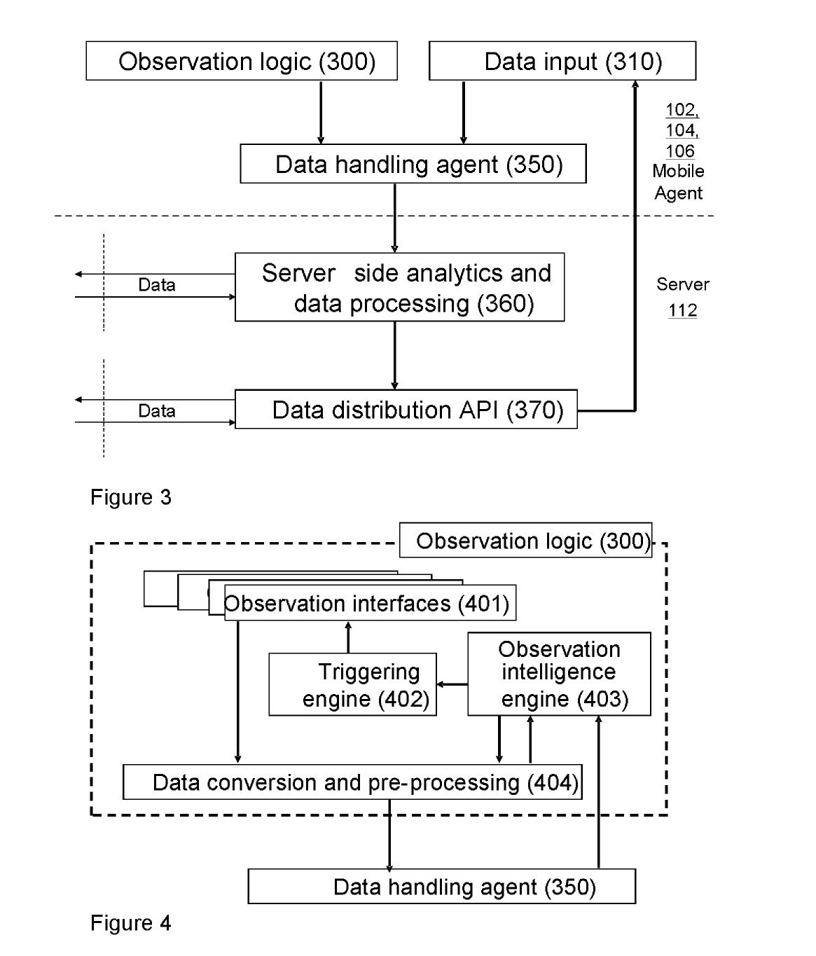

FIG. 3 represents a flow diagram of one embodiment of the system incorporating both the mobile agent and the server arrangement in accordance with the present invention.

One primary function of the agent, as the flow diagram illustrates by visualizing the data flow, is to observe events, actions and/or properties in the wireless devices (notice the observation logic, 300), and to perform pre-processing for the observed data and manage the device-based intelligence regarding data handling (notice the data handling agent, 350). In addition, the agent is enabled, by the data input module 310, to receive data from the server, the data including e.g. metadata, contextual data, and/or updates regarding data handling rules and observation requirements. Further, the data input module 310 may also be used for inputting new observation code and modules, which can be thus incorporated in the agent software logic over-the-air. The responsibility of the data handling agent 350 is generally to coordinate the operations of the observers, maintain and control the overall intelligence, coordinate data storing and transmission, and preferably update the intelligence (via learning and adaptation) on the agent side. Technically the data handling agent may be implemented as a server process in the agent, serving multiple clients such as different observers.

On the server side, the data that is transmitted is processed (filtered, enriched, combined, analyzed, and/or normalized, and so on), in the server-side analytics and data processing module 360. This module 360 serves in a central role, being able to use not only the information from devices, but also externally available data, such as temperatures and location names. In addition, the server is able to apply collective intelligence on the data, for instance, to automatically and seamlessly to identify relationships between data points. The server may observe that two friends are located next to each other provided that each of them sends a location update from close to each other at approximately same time, for instance. As one particularly advantageous feature, the server deploys intelligent algorithms making sense out of the multi-dimensional, geographical, social, contextual and/or behavioural datasets that it handles in its relational (and in many cases semantic) databases.

The whole system has been designed efficiently so that the server is much more than just a cache. Quite the contrary, it implements a centralized intelligence engine coordinating the operations of the aggregate system, the clients of which being able to utilize its collective intelligence through two-way communication protocols and their own adaptive and learning logic. Finally, a data distribution API 370 is also located on the server side. It advantageously serves as a simultaneous starting and ending point of the data flow, i.e. providing access to internal and external interfaces for query data. This API is flexible as it not only provides simple one-dimensional status information, but can provide a stream of activities as well. For example, one potential query might be to provide a list of movement activities during the last seven day in the New York Manhattan area, during which the temperature has been higher than 30 Celsius degrees, and at least one of the user's friends has been in the radius of five kilometres. In contrast to prior art, the system of the present invention does not provide fixed data pipe-lines or interfaces, but instead builds the logic on top of the flexible multi-use data distribution API.

In FIG. 4, an embodiment of the data observation logic 300 is represented. A number of observation interfaces 401 handle the observations, sense the context, activities and device information, and stream the data to the data conversion and pre-processing layer 404, which is then configured to perform desired raw-level data conversions and processing activities on the data. For example, it may convert pure observations into more informative and easier-to-handle standardized XML format. The role of the triggering engine 402 is to coordinate observations by optimally triggering the sensors. The observation intelligence engine 403 receives data from outside (e.g. from the server-side, directed by the mobile intelligence engine 553), maintaining the rules of data observations and pre-processing, guiding the respective modules.

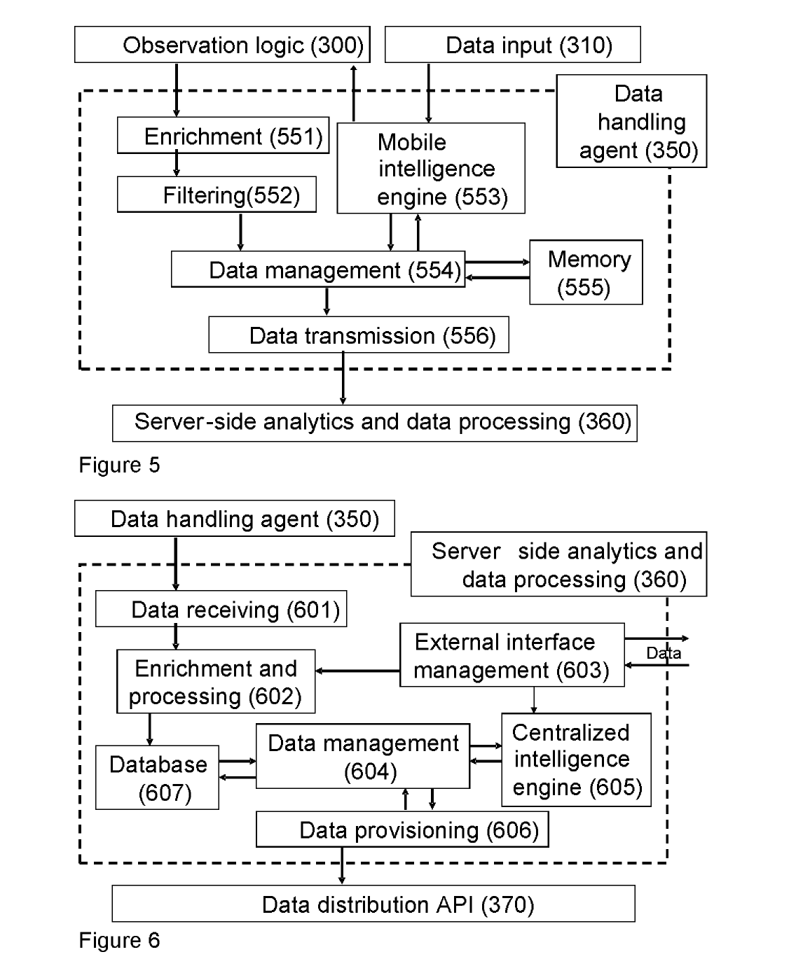

With reference to FIG. 5, an embodiment of the data handling agent 350 is described. The data handling agent may be configured to receive observation data from the observation logic 300 through the enrichment module 351. This means that the XML data coming from the mobile device is enriched e.g. with other data points locally known at that moment, for example the timestamp of the previous data point or identification codes and/or signal strengths of the currently active or all visible cell towers. The filtering logic 552 is next applied to data, meaning basically the removal of redundant or useless data, and also sorting and otherwise validating the data stream. The data management module 554 is then responsible for otherwise managing the data, including but not limited to data analysis. This module also coordinates locally storing the data in the memory 555 and feeding thereof to the data transmission module 556, and thus further towards the server 360. The data management module 554 also extracts information, learns from it, and preferably feeds it substantially in real-time fashion back to the mobile intelligence engine 553 coordinating the whole agent side of the system. For example, it can be observed that active cellular tower identification codes are changing rapidly, this meaning that the topology of the network at that point is very dense (tower-wise) or that the wireless device is moving. The mobile intelligence engine 553 can incorporate that information, and consequently coordinate the observation intelligence engine 403 of the observation engine to more frequently observe locations and movements. The mobile intelligence engine 553 also coordinates optimal transmission of data through the data management layer. The data input module 310 receives data from the server-side and feeds it to the mobile intelligence engine 553.

In FIG. 6 an embodiment of the server-side analytics and data processing module 360 is illustrated. The data is received from the data handling agent 350 of the mobile terminal by the data receiving module 601. This module is preferably scalable, enabled to receive data points from multiple wireless devices at the same time. Next on the server-side is the data enrichment and processing layer 602, in which relevant, possibly contextual, processes are applied on the incoming data. This module may be configured to apply the external interface management module 603 module in order to obtain information from outside, such as weather information supplied by weather data provider. The processed data is fed to the data management module 604 that stores the data into one or more databases 607 and maintains the database(s). This module is guided by the centralized intelligence engine 605 that can also incorporate information from external interfaces. The database 607 is intelligent, holding e.g. more accurate and granular data for the most current data, and optimizing the storage of historical data by averaging statistics and decreasing the resolution, for example. The data provisioning layer 606 is enabled to feed data stored in the database(s) 604 to the data distribution API 370.

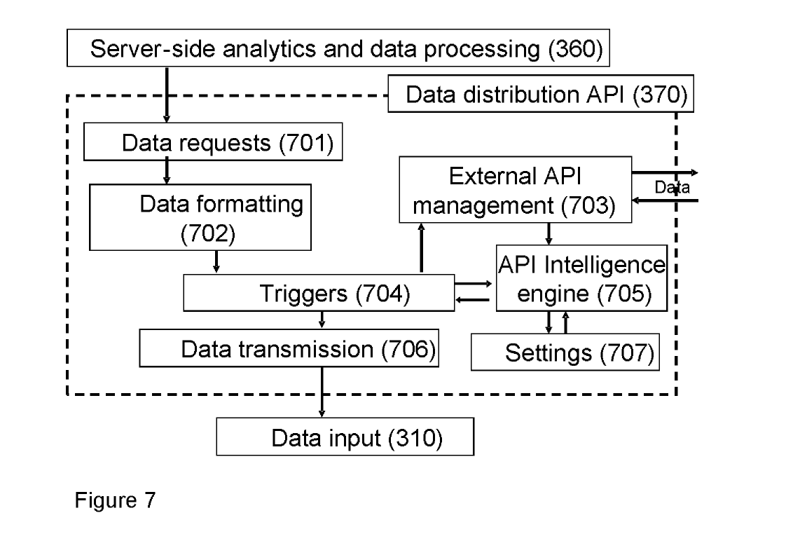

In FIG. 7, an embodiment of the data distribution API 370 is depicted. The data request module 701 queries the databases and further directs the data to the data formatting module 702 that is responsible for converting the data and changing it to the appropriate format. The triggering logic 704 is responsible for guiding the data transmission module 706 that eventually sends the data to the data input module 310 of the mobile terminals, and/or to external interfaces through the external API management module 703. This module is naturally of importance, as in many use cases data shall be provided to other services of the communication network. Indeed, the overall system described in this document is primarily designed for data collection, management, analysis and distribution functionalities. The API intelligence engine 705 coordinates the operations of the data distribution API 370, verifying, for example, user settings (privacy, data distribution guidelines) on the basis of a separate settings module 707 preferably always when transmitting data. Accordingly, the invention facilitates proper and efficient coordination of data possibly flowing from multiple devices (sources) to multiple use cases (targets; for example web services and physical devices) by the described centralized platform for data management.

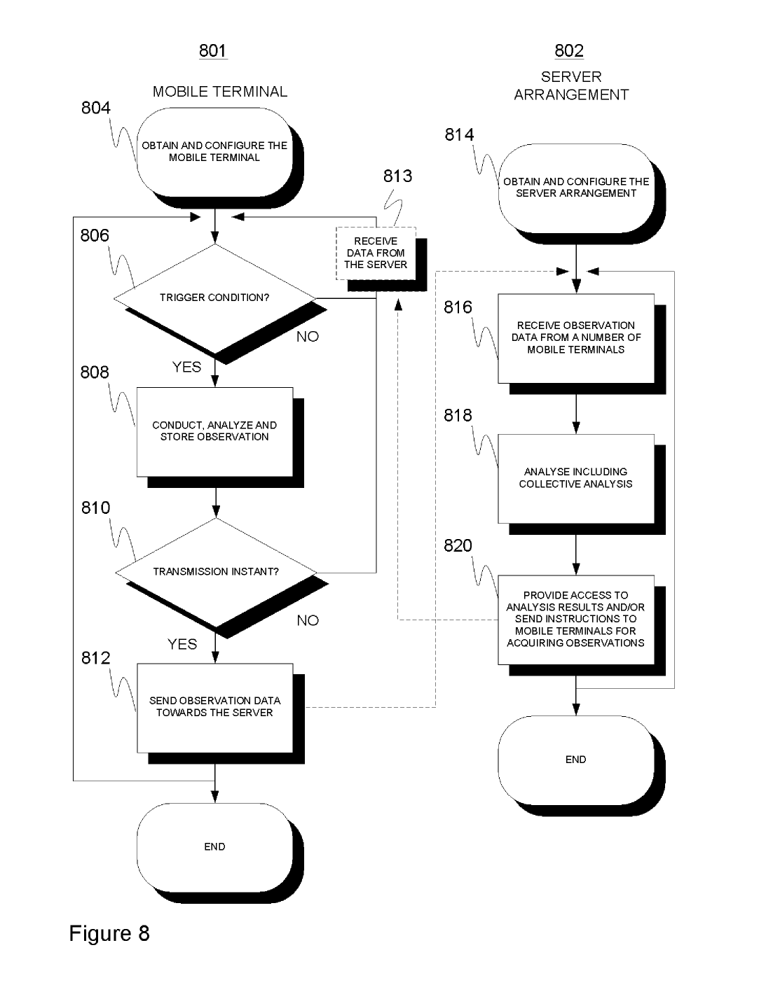

FIG. 8 is a combined flow diagram of two embodiments of a method in accordance with the present invention to be performed by a mobile terminal and a server arrangement, respectively. On the left side 801 operations performed in the mobile terminal are illustrated whereas the right side process 802 depicts the tasks of the server arrangement. The both entities may communicate with each other as highlighted by the broken arrows. Loop-back arrows depict the real-time nature of the invention, i.e. the method steps may be executed repeatedly in a sequential or selective manner.

At 804 a mobile terminal, such as a smartphone, capable of executing the agent software in accordance with an embodiment of the present invention is obtained and configured by acquiring the software (“mobile agent”) and adjusting the settings thereof, for example. Then the existing active and passive triggers are served upon noticing a fulfillment of a triggering condition 806 by conducting 808 the associated observations, and further analyzing and storing the associated data. Upon a suitable time instant 810 the aggregated observation data are transmitted towards the server for further analysis, storage, feedback (for example, observation control) and/or distribution purposes. Step 813 illustrates the receipt of control data, e.g. control instructions, from the server for conducting the observations and/or related tasks such as data distribution.

At 814 the server arrangement in accordance with an embodiment of the present invention is obtained and configured by acquiring the software and adjusting the settings thereof, for example. Observation data are received 816 from a number of mobile terminals and analyzed 818 comprising both context and behavioural modelling, wherein the observation data by a plurality of mobile terminals is preferably collectively applied together with optional supplementary data. At 820 conducting observations in the mobile terminals is further adaptively guided by transmitting associated control data established on the basis of the analysis, e.g. triggering rules for active observations and/or event definitions for passive observations, towards one or mobile terminals. Also other external entities, such as servers, may be provided with access to analysis results.

A skilled person realizes that the illustrated flow diagrams are merely exemplary and the nature and number of method steps, not forgetting the mutual order thereof, may be dynamically and/or use case—specifically adjusted.

Few examples are given hereinafter to provide means to a skilled reader on how to implement various more complex features of the embodiments of the present invention in different use scenarios.

The aforesaid triggering logic may either actively or passively trigger observations. Passive triggers are tied to a certain event or action, which can be sensed and consequently the actual observation can be conducted and log entry written. Typical examples how the invention may exploit this logic in smartphones available today, are the observations associated with changing cellular towers, changing battery levels, and/or communication actions. In contrast to prior art, the present invention applies concrete algorithms that guide the triggering logic. Such logic is based on the number and/or frequency of sensor outputs. For instance, the actual observation(s) can be made after a certain number of cellular tower changes have been observed within a defined time limit. Below a pseudo-code representation of the mentioned passive trigger that is based on the frequency of observed changes in a certain sensor A:

Examplary Code 1: Trigger based on changes/actions/events during a time cycle

```
RESET:
SET CHANGES = 0
SET PREVIOUS = 0
SET START = TIME
LOOP
  OBSERVE A
  IF A ≠ PREVIOUS
  CHANGES = CHANGES + 1
  IF (TIME-START) < THRESHOLD AND CHANGES >
  LIMIT TRIGGER_GO = 1
UNTIL (TIME-START) > THRESHOLD OR TRIGGER_GO = 1
IF TRIGGER_GO = 1 THEN TRIGGER
GO TO RESET
```

Active triggers may be defined not as tied to the sensors, but based on fixed time limits and/or other triggering rules obtained from the server side or being user-defined.

Another functionality of different embodiments of the present invention is the observation logic, which is preferably passive and in a number of ways scalable, as each observation may be run in a separate thread, appearing as a client to the data handling agent 350. The overall software implementing the mobile agent is advantageously not a separate application that has to be specifically launched.

Instead, it preferably loads itself to the memory when the device powers up and runs invisibly/transparently on the background ever since. It independently communicates with the server and starts new observers, collecting the data that they feed regarding behavioural and contextual observations. There are various kinds of observations that can be done, for example, including at least one element selected from the group consisting of:
1. Currently active cellular tower and/or all visible cell towers and their corresponding signal strengths (reflecting the current geographical location)
2. Voice calls and messages (e.g. outbound/inbound SMS, MMS, regular voice calls, emails etc)
3. Calendar appointments (meetings, notes, anniversaries etc.)
4. Application usage (web browser usage, calendar usage, camera usage)
5. Data sessions (opening the PDP (Packet Data Protocol) context, transferring data over Internet protocols)
6. Media consumption (music and video playback, streaming content from the Internet)
7. Battery status (status of the battery, i.e. how many bars there are left)
8. Temperature (measured temperature inside/outside of the phone)

A third functionality of the embodiments of the present invention is the device-based pre-processing. Outlier filtering procedures, data conversions such as conversions from raw hexadecimal observations to the standardized XML Unicode feed, factor analysis, weighted averaging and/or other such methods may be applied in certain situations in the mobile agent. More tangibly, locally available information may be matched to data points, a good example being the attachment of time stamps and/or currently active cellular tower identification codes to the data points. By doing this already on the mobile side, the load and complexity of the server-side is minimized. On the other hand, the implementations of the present invention preferably restrict the procedures of the agent side on data processing as the sustainable and long-term data storage and intelligence rules accompanied with the higher level data analysis practices advantageously reside on the server-side.

Fourthly, optimal pushing of data to servers, together with parallel, frequent, data receiving from the server, are preferred functionalities of the system. The mobile intelligence engine of the agent can decide based on various parameters the optimal times of data sending and receiving. For example, the algorithm responsible for triggering this logic may be based on at least one condition selected from the group consisting of:
1. Location of the device
2. Movement of the device (e.g. movement status)
3. Time of day
4. Day of week
5. Behavioural input (user's actions, such as voice calls)
6. Device status information (battery status, temperature, memory capacity)

In data transmission both authentication and encryption methods and/or algorithms may be used, securing thus the transmission of potentially private information.

Fifth, data mining practices on the server-side are desired processes of the overall system, the server side in general playing one key part of the whole architecture. The server side can holistically input all the data from the devices, recognizing any possible patterns and processing data, and deriving information based on statistical analysis. Procedures, such as multi-variate generalized non-linear and linear regression methods, factor analysis, cluster analysis, classification utilizing, for example, neural networks, non-parametric tests and survival analysis may be automatically used, though discretely, on the received and locally stored data.

To provide a skilled reader with few tangible data analysis examples, potential embodiments of the algorithms of the context modeling framework and user segmentation model are reviewed hereinafter.

In context modeling, a graph may be formed to illustrate cellular towers. Instead of data collected by individual users (as done by most prior art arrangements), a more comprehensive dataset by a plurality of users, e.g. substantially all users, is preferably used. The nodes of the graph correspond to cellular towers and the weights of the links reflect the observed number of 2-way jumps (for example, a jump from base station A to base station B and back) in the network (instead of relying on one-way jumps, which can also reflect movements instead of access jumps when halt), thus better communicating their possible physical closeness. A cluster analysis approach (e.g. any one of the publicly available approaches) may be then applied and many cellular towers grouped together to form one physical area, though based on non-geographical data points. Later on, user-inputted or pre-coded semantic information such as “home” or “office” may be added based on time distribution based semantic algorithms. Even geo-location information can be attached to the cellular towers, if appropriate observations can be made in the agent, or alternatively, server-based matching technologies can be used.

In a similar fashion, a plurality of users can be clustered to form behaviourally coherent groups. The nodes of the graph represent this time users instead of cellular towers. The weights between the nodes may be Pearson correlation coefficients (or equivalent), calculated, for example, based on activity (e.g. overall device usage in minutes of usage per day) or location-based variables (for example distance between users). In the examples here, the original data to describe edges between nodes may be multi-dimensional, in other words meaning that multiple weights between nodes can be calculated in the first place.

In view of automatic clustering, a modularity-based approach to analyze the graphs produced by the platform is described. The modularity may be defined as follows. Denote by eᵢⱼ half of the fraction of edges in the graph that connect vertices from community i to community j, given that i≠j. Half of the fraction is chosen instead of the full fraction since the normalization demands that eᵢⱼ+eⱼᵢ equals the total fraction. Denote also by eᵢᵢ the fraction of edges inside community i.

Using this notation, the sum

$${b}_{i} = {\sum }_{i = 1}^{N} {e}_{ii} \qquad ( 1 )$$

equals the fraction of edges that fall within the communities of all edges, while

$${a}_{i} = {\sum }_{j = 1}^{N} {e}_{ij} \qquad ( 2 )$$

is the fraction of ends of edges that emanate from vertices in group i. Now, if all edges were connected at random, the fraction of them inside community i would be aᵢ². This lets one define the modularity Q as

$$Q = {\sum }_{i = 1}^{N} ( {e}_{ii} - {a}_{i}^{2} ) \qquad ( 3 )$$

If the edges are random, the modularity equals zero, whereas values Q>0 indicate a clustered structure. Usually values of about Q>0.3 or 0.4 can be considered as signs of significant clustering.

The used method of optimizing modularity works as follows. Let initially each vertex form a community of its own. Consider all possible aggregations of two communities into one, and compute the modularity after these joins. Choose the one with the highest modularity and aggregate the communities together. Repeat this procedure iteratively for the new set of communities until there is no pair of two clusters the joining of which would increase the modularity. The communities at this point are then the best division of the original graph into communities in terms of the algorithm.

Denote by dᵢⱼ the measurement of node i in measurement group j. By dividing the values with the measurement group averaged ones

$${α}_{j} = \frac{{\sum }_{i = 1}^{{N}_{p}} {d}_{ij}}{{N}_{p}} \qquad ( 4 )$$

where Nₚ is the number of nodes, the scaled measurements βᵢⱼ can be defined as

$${β}_{ij} = \frac{{d}_{ji}}{{α}_{j}} \qquad ( 5 )$$

leading to the vectors

γₖ=(βₖⱼ)₍ⱼ₌₁₎^{(N}^{_{α}}⁾ (6)

describing the patterns of individual node k. Here, Nₐ is the number of measurement groups. Using these vectors, it is possible to define the similarity coefficients for nodes k and l as explained below.

Using these similarity coefficients, a fully connected weighted graph may be built with the edge between nodes k and l having the weight wₖₗ determined, for example, by using Pearson correlation coefficient. The algorithm takes the weights of the edges into account. This may be done simply by redefining the factors eᵢⱼ to

$${e}_{ij} = \frac{{w}_{ij}}{2 {\sum }_{x} {\sum }_{y > x} {w}_{xy}} \qquad ( 7 )$$

where the summation is over all pairs of vertices. Newman's widely used algorithm may be applied to produce a division of the nodes into clusters.

In addition to node clustering in the variety of relevant applications, various data mining procedures may be applied on the fly. For example, by using weighted averaging, the current movement activity of users can be updated on the servers. The outputs of all data mining practices can be substantially immediately taken into account in mobile agent operations. For example, by observing a link between two users, based on the conducted location based clustering algorithm (optionally incorporating predictive logic regarding the next hour's locations), more accurate observations can be immediately made in the respective user's wireless devices. For example, the devices can observe and servers analyse similarities in music consumption, this being a potential factor contributing to the likelihood of two users being interested in, for example, dating each other.

The data stored in the databases, in the raw-level format, is e.g. in Unicode format, and various relations may be utilized in optimally storing the data. For example, a typical way to define an approximate geolocation is to identify cellular tower (base station) identification codes. Instead of storing all of the codes (MCC (mobile country code), MNC (mobile network code), LAC (location area code), CID (cell-id) in a GSM network, for example), the system may create a simple index for each tower, and this index is then used in mapping data points to cellular towers. In addition to heavy use of relations in linking data points to users, locations, context, weather and any other things, the database preferably utilizes time-based gradual aggregation of data as mentioned hereinbefore so that for the older data not as accurate, precise and granular data point storage is utilized as for the more recent data. For example, for the life feed items of the last week, a more accurate location for each of them might be stored. In contrast, the life feed data from e.g. a year ago can be equipped with only one day-level weighted average of the geo-location for each country.

In the data distribution API, today's virtualized and scalable clusters of databases may be used, optionally with a semantic database model enabling various kinds of queries, from direct to more complex, semantically formulated ones. The data distribution API shall advantageously facilitate both pull and push model of data distribution. In addition, it centrally manages each user's data based on universal privacy settings, data sharing conditions, and/or other centralized data management settings the user has defined. The data distribution API secures that the data flows efficiently to proper interfaces in a correct format. The data distribution API queries the data from the server-side data management module 604, physically for example from the database clusters 607 by utilizing the data provisioning module 606 as the main interface. The data may be outputted in various formats. Widely used standards such as XML and GeoRSS may be applied for pre-defined data streams. In addition, customized interfaces can be easily built between the data distribution API and widely used external services offered in the communication network, using the request formats of the API. Some exemplary request types include at least one element selected from the group consisting of:
1. Status information retrieval (e.g. location, context, profile status)
2. Users currently in a certain location
3. Users having used the web browser at least once during a certain time period
4. List of countries a specific user has ever visited
5. The most typical location for a specific user
6. Likelihood estimates (predictions) for a particular user's location in 1 hour
7. The image content feed from a particular location during a certain time period
8. Updated behavioural profile of a user based on application usage patterns

Parameters that may be included in the queries comprise at least one element selected from the group consisting of:
1. User identification
2. Time
3. Location (old, current, future)
4. Status information (“moving”, “busy”)
5. Context (semantic, for example home, school, office, bus)
6. Behavioural patterns (application usage)

The data distribution API facilitates even external widgets or applications to perform queries in the database. For example, a platform-specific application may be built for social networking services, with its own user interface and functionalities that plots the data provided by this system through the data distribution API. The data distribution API does not take a standpoint on how the data is to be used. Rather, it specifies a multi-use interface to easily make queries to the intelligent and optimized database of life feed data. The same data distribution API can be combined with the external interface management module 603 to input data to the system's cumulative databases, instead of just distributing data from the database.

The scope of the invention can be found in the following claims. Notwithstanding the various embodiments described hereinbefore in detail, a person skilled in the art will understand that different modifications may be introduced to the explicitly disclosed solutions without diverging from the fulcrum of the present invention as set forth in this text and defined by the independent claims.

1. A mobile terminal (102, 104, 106) for providing life observations, such as a smartphone, comprising a processing entity (220) for processing data, a memory (222) for storing data, a wireless transceiver (224) for wirelessly transmitting and receiving data relative to external entities, such as a communications network infrastructure, the mobile terminal further comprising
an observation logic (300), executed by said processing entity and stored in said memory, for conducting active and passive observations on events, actions and/or properties detectable relative to the mobile terminal in response to active and passive triggers, respectively, wherein each active trigger is associated with a triggering rule, such as a timing rule, for conducting a related observation, and each passive trigger is associated with a change in the observation environment, such as a certain event or action, the occurrence of which in the mobile terminal triggers conducting the observation linked to said passive trigger, and
a data handling logic (350), executed by said processing entity and stored in said memory, for storing, analysing, and aggregating observation data points of the gathered observation data to timed observation data transmissions via the wireless transceiver towards an external entity.

2. The mobile terminal of claim 1, configured to temporally monitor the instances of actions and/or events taking place in the mobile terminal over a time period and to define, on the basis of a detected historically substantially regularly occurred action or event, an active trigger incorporating a timer for conducting an active observation the timing of which is adjusted relative to the detected substantially regular timing of the action or event.

3. The mobile terminal of claim 1, wherein a passive trigger for conducting a passive observation is associated with detecting a plurality of predetermined changes in the observation environment, such as multiple instances of the same or different events or actions, optionally within a predetermined time window.

4. The mobile terminal of claim 1, configured to combine a first data point relative to a first observation, such as location observation, with a second data point relative to a second observation, such as a communication action observation, supplemented with a time stamp and optional further information such as temperature information.

5. The mobile terminal of claim 1, configured to observe at least one element selected from the group consisting of: active cell tower, all visible cell towers and their corresponding signal strengths, a call, a message, a calendar entry, application usage, camera usage, data transfer, media consumption, sound input, sound output, user input, profile change, tactile output, battery status, device status, GPS coordinates, blog entry, micro-blog entry, diary entry, a notebook entry, a phonebook operation, and temperature.

6. The mobile terminal of claim 1, configured to time observation data transmissions based on at least one condition selected from the group consisting of: location of the device, movement of the device, context of the device, time of day, day of week, behavioural input, and device status information.

7. The mobile terminal of claim 1, configured to process the observation data prior to transmission utilizing at least one technique selected from the group consisting of: outlier filtering, data conversion such as conversion from raw hexadecimal observation to the standardized XML Unicode feed, factor analysis, weighted averaging, data sorting, and matching of locally available information with a data point.

8. The mobile terminal of claim 1, configured to extract information, such as the frequency of occurrences of an action or an event, from a number of observations and adapt the observation logic accordingly, optionally by conducting the associated observation more or less frequently.

9. A server arrangement (112, 234, 258) for analysis, distribution and control of mobile terminal-based life observations relative to a number of mobile users comprising a processing entity (250) for processing data, a memory (252) for storing data, and a communications interface (254) for transferring data,
an analytics and data processing logic (360), executed by said processing entity and stored in said memory, for obtaining triggered observation data transmissions on events, actions and/or properties relative to each mobile terminal from a plurality of mobile terminals and optionally supplementary data from a number of other external data sources, and performing analysis, said analysis comprising context and behavioural modelling, collectively applying the observation data by a plurality of mobile terminals and optional supplementary data, and
a data distribution logic (370), executed by said processing entity and stored in said memory, for guiding conducting observations in the mobile terminals by control data established on the basis of the analysis and sent towards mobile terminals via the communications interface, and optionally further providing other external entities with analysis results.

10. The server arrangement of claim 9, configured to apply gradual aggregation and temporal resolution adjustment for the obtained data such that the more current data is retained more granular and accurate than the older data.

11. The server arrangement of claim 9, configured to identify relationships between data points of the received observation data.

12. The server arrangement of claim 9, configured to transmit intelligent messages, such as geo-social advertisements or contextual notifications, towards mobile terminals such that upon detecting, on the basis of the received observation data, one user's presence in a predetermined location, the server arrangement is arranged to send a message, via the data distribution logic, to the mobile terminal of the user informing of an option to transmit a location-context dependent message to one or more mobile terminals of respective one or more friends located in the neighbourhood based on the observation data received from said mobile terminals of said one or more friends.

13. The server arrangement of claim 9, configured to model the context or user behaviour by first constructing an initial graph with nodes representing distinguishable locations or users, respectively, and the weights of the links between them indicating the associated distances or correlation coefficients, and then applying a predetermined clustering algorithm so as to group at least two nodes together to form a plurality of clusters from the nodes.

14. The server arrangement of claim 9, configured to identify semantic contexts, such as home or work, on the basis of a time distribution-based semantic algorithm applied for the observation data.

15. The server arrangement of claim 9, configured to apply, on the received observation data, at least one data mining or statistical tool selected from the group consisting of: multi-variate generalized non-linear regression, classification, linear regression, neural network, factor analysis, cluster analysis, non-parametric test and survival analysis.

16. The server arrangement of claim 9, configured to provide an analysis result comprising at least one element selected from the group consisting of: user location, user context, users currently in a certain location, users having used a predetermined application, such as the web browser, at least once during a predetermined time period, a list of countries a specific user has visited, the most common location for a specific user, a likelihood estimate for a particular user's location at a predetermined instant, and updated behavioural profile of a user based on the application usage patterns.

17. The server arrangement of claim 9, configured to determine the data for the output of the data distribution logic on the basis of at least one received query element selected from the group consisting of: user id, time, location, user status, context, and behavioural pattern.

18. A method for providing life observations based on events, actions and/or properties detectable in a mobile device, comprising
determining (804) a number of active and passive triggers for conducting active and passive observations on events, actions and/or properties detectable relative to the device, respectively, each active trigger associated with a triggering rule, such as a timing rule, for conducting a related observation, and each passive trigger associated with a change in the observation environment, such as a certain event or action, the occurrence of which in the device triggers conducting the observation linked to said passive trigger, conducting (806, 808) active and passive observations in the device in response to the fulfillment of corresponding triggering conditions determined by the active and passive triggers, respectively, and
storing, analysing, and aggregating observation data points of the gathered observation data to timed observation data transmissions (810, 812) towards an external entity.

19. A method for analysing and controlling mobile device-based life observations relative to a number of mobile users, comprising
obtaining (816) triggered observation data transmissions on events, actions and/or properties relative to each mobile device from a plurality of mobile devices and optionally supplementary data from a number of other external data sources,
performing (818) analysis, said analysis comprising context and behavioural modelling, collectively applying the observation data by the plurality of mobile devices and optional supplementary data, and
guiding (820) conducting observations in the mobile devices by control data established on the basis of the analysis and sent towards mobile devices via the communications interface, and optionally further providing other external entities with analysis results.

20. The mobile terminal of claim 2, wherein a passive trigger for conducting a passive observation is associated with detecting a plurality of predetermined changes in the observation environment, such as multiple instances of the same or different events or actions, optionally within a predetermined time window.
